(19) United States
(12) Patent Application Publication
(10) Pub. No.: US 2024/0417293 A1
(43) Pub. Date: Dec. 19, 2024

(54) PFAS TREATMENT USING GAC, REACTIVATION AND THERMAL DESTRUCTION

(71) Applicant: EVOQUA WATER TECHNOLOGIES LLC, Pittsburgh, PA (US)

(72) Inventors: Vincent Grieco, Gibsonia, PA (US); Gary C. Ganzi, Lexington, MA (US)

(21) Appl. No.: 18/715,467

(22) PCT Filed: Nov. 29, 2022
(86) PCT No.: PCT/US2022/051183

§ 371 Date: May 31, 2024

Related U.S. Application Data
(60) Provisional application No. 63/283,560, filed on Nov. 29, 2021.

(51) Int. Cl. C02F 1/72; C02F 1/00; C02F 1/28; C02F 1/42; C02F 101/14

(52) U.S. Cl. CPC C02F 1/72; C02F 1/001; C02F 1/283; C02F 1/42; C02F 2101/14; C02F 2303/16

(57) ABSTRACT

Systems and methods for treating activated carbon used in treatment of water and wastewater containing PFAS are disclosed. A vapor phase granular activated carbon (GAC) column or an internal combustion engine may be fluidly connected downstream of a thermal oxidation process to polish a vapor phase effluent associated with reactivation.

### CROSS-REFERENCE TO RELATED APPLICATION

This application claims priority under 35 U.S.C. § 119(e) to U.S. Provisional Patent Application Ser. No. 63/283,560, filed on Nov. 29, 2021 and titled “PFAS TREATMENT USING GAC, REACTIVATION AND THERMAL DESTRUCTION,” the entire disclosure of which is hereby incorporated herein by reference in its entirety for all purposes.

### FIELD OF TECHNOLOGY

Aspects and embodiments disclosed herein are generally related to the removal and elimination of per- and polyfluoroalkyl substances (PFAS) from water.

### BACKGROUND

There is rising concern about the presence of various contaminants in municipal wastewater, surface water, drinking water, and groundwater. For example, perchlorate ions in water are of concern, as well as PFAS and PFAS precursors, along with a general concern with respect to total organic carbon (TOC).

PFAS are man-made chemicals used in numerous of industries. PFAS molecules typically do not break down naturally. As a result, PFAS molecules accumulate in the environment and within the human body. PFAS molecules contaminate food products, commercial household and workplace products, municipal water, agricultural soil and irrigation water, and even drinking water. PFAS molecules have been shown to cause adverse health effects in humans and animals.

In November 2022, the U.S. Environmental Protection Agency (EPA) issued an updated Contaminant Candidate List (CCL 5) which includes PFAS as a broad class inclusive of any PFAS that fits the revised CCL 5 structural definition of per- and polyfluoroalkyl substances (PFAS), namely chemicals that contain at least one of the following three structures:
R—(CF2)-CF(R′)R″, where both the CF2 and CF moieties are saturated carbons, and none of the R groups can be hydrogen.
R-CF2OCF2-R′, where both the CF2 moieties are saturated carbons, and none of the R groups can be hydrogen.
CF3C(CF3)RR′, where all the carbons are saturated, and none of the R groups can be hydrogen.

The EPA's Comptox Database includes a CCL 5 PFAS list of over 10,000 PFAS substances that meet the Final CCL 5 PFAS definition. The EPA has committed to being proactive as emerging PFAS contaminants or contaminant groups continue to be identified and the term PFAS as used herein is intended to be all inclusive in this regard.

### SUMMARY

In accordance with one or more aspects, a method of treating granular activated carbon (GAC) used in treatment of water or wastewater containing a per- or poly-fluoroalkyl substance (PFAS) is disclosed. The method may comprise reactivating GAC containing adsorbed PFAS, subjecting a first vapor phase effluent associated with reactivation to a thermal oxidation process to produce an intermediate vapor effluent, and polishing the intermediate vapor effluent with a treatment capable of eliminating PFAS to produce a product effluent.

In some aspects, the PFAS may comprise perfluorooctane sulfonic acid (PFOS), perfluorooctanoic acid (PFOA), or perfluoroalkyl ether carboxylic acid.

In some aspects, the thermal oxidation process may comprise combustion. The thermal oxidation process may involve a process temperature in a range of about 800° C. to about 1200° C.

In some aspects, the thermal oxidation process may further comprise wet scrubbing. The method may further comprise recirculating scrubbing fluid through a particle filter. The method may further comprise recirculating scrubbing fluid through a liquid phase GAC column. The method may further comprise recirculating scrubbing fluid through a liquid phase ion exchange column.

In some aspects, polishing may involve subjecting the intermediate vapor effluent to a vapor phase GAC column.

In some aspects, polishing may involve subjecting the intermediate vapor effluent to an internal combustion engine.

In some aspects, the method further comprise reactivating spent carbon associated with a liquid phase GAC column and/or a vapor phase GAC column.

In some aspects, the method may further comprise concentrating or dewatering a process stream including GAC containing adsorbed PFAS prior to reactivation.

In some aspects, the method may further comprise returning a fraction including but not limited to essentially all the reactivated GAC to a water or wastewater treatment process.

In some aspects, the method may further comprise venting the product effluent to atmosphere.

In some aspects, the intermediate vapor effluent may be characterized by a PFAS elimination rate of at least about 99% by weight for at least one of the PFAS compounds in the GAC prior to reactivation. In at least some non-limiting aspects, the intermediate vapor effluent may be characterized by a PFAS elimination rate of at least about 99.99% by weight for at least one of the PFAS compounds in the GAC prior to reactivation.

In accordance with one or more aspects, a system for treating granular activated carbon (GAC) used in treatment of-water or wastewater containing a per- or poly-fluoroalkyl substance (PFAS) is disclosed. The system may comprise a GAC reactivation kiln, a thermal destruction unit fluidly connected downstream of a first effluent associated with the GAC reactivation kiln, the thermal destruction unit configured to produce an intermediate vapor effluent, and a polishing unit fluidly connected downstream of the intermediate vapor effluent associated with the reactivation kiln and thermal destruction unit.

In some aspects, the thermal destruction unit may comprise a thermal oxidizer.

In some aspects, the thermal destruction unit may further comprise a wet scrubber. The system may further comprise a recirculation subsystem associated with the wet scrubber. The recirculation subsystem may include at least one of a particle filter and a liquid phase GAC column. The recirculation subsystem may include at least one of a particle filter and an ion exchange column.

In some aspects, the polishing unit may comprise a vapor phase GAC column. In some aspects, the polishing unit may comprise an internal combustion engine.

In some aspects, the intermediate vapor effluent may be controlled to meet a PFAS elimination rate of at least about 99% by weight for at least one of the PFAS compounds originally in the GAC. In at least some non-limiting aspects, the intermediate vapor effluent may be controlled to meet a PFAS elimination rate of at least about 99.99% by weight for at least one of the PFAS compounds originally in the GAC.

In accordance with one or more aspects, a method of retrofitting a system for treating activated carbon used in treatment of water and wastewater containing a per- or poly-fluoroalkyl substance (PFAS) is disclosed. The method may comprise fluidly connecting a vapor phase granular activated carbon (GAC) column downstream of a thermal oxidizer. The method may comprise fluidly connecting an internal combustion engine downstream of a thermal oxidizer.

The disclosure contemplates all combinations of any one or more of the foregoing aspects and/or embodiments, as well as combinations with any one or more of the embodiments set forth in the detailed description and any examples.

### BRIEF DESCRIPTION OF THE DRAWING

The accompanying drawings are not drawn to scale. In the drawings, each identical or nearly identical component that is illustrated in the various figures is represented by a like numeral. For purposes of clarity, not every component may be labeled in every drawing. In the drawings:

FIG. 1 presents a process flow diagram associated with systems and methods for treating granular activated carbon (GAC) used in treatment of water or wastewater containing a per- or poly-fluoroalkyl substance (PFAS) in accordance with one or more embodiments.

### DETAILED DESCRIPTION

In accordance with one or more embodiments, granular activated carbon (GAC) used for treating water and wastewater containing a per- or poly-fluoroalkyl substance (PFAS) may be treated. GAC loaded with PFAS may be reactivated for reuse. A related vapor phase effluent may be treated to eliminate PFAS prior to environmental discharge. The vapor phase effluent may undergo a thermal destruction process to bring any residual organic compounds down to or below an acceptable limit for discharge. In at least some embodiments, the PFAS level of this intermediate effluent may already be at or below detectable limits. In accordance with one or more embodiments, this intermediate vapor phase effluent may be polished in accordance with one or more embodiments to further ensure PFAS destruction so as to meet evolving discharge guidance and requirements. Beneficially, this polishing may be performed in an efficient and effective manner as described further herein.

PFAS are organic compounds consisting of fluorine, carbon and heteroatoms such as oxygen, nitrogen and sulfur. PFAS is a broad class of molecules that further includes polyfluoroalkyl substances. PFAS are carbon chain molecules having carbon-fluorine bonds. Polyfluoroalkyl substances are carbon chain molecules having carbon-fluorine bonds and also carbon-hydrogen bonds. Common PFAS molecules include perfluorooctanoic acid (PFOA), perfluorooctanesulfonic acid (PFOS), and short-chain organofluorine chemical compounds, such as the ammonium salt of hexafluoropropylene oxide dimer acid (HFPO-DA) fluoride (also known as GenX). PFAS molecules typically have a tail with a hydrophobic end and an ionized end. The hydrophobicity of fluorocarbons and extreme electronegativity of fluorine give these and similar compounds unusual properties. Initially, many of these compounds were used as gases in the fabrication of integrated circuits. The ozone destroying properties of these molecules restricted their use and resulted in methods to prevent their release into the atmosphere. But other PFAS such as fluoro-surfactants have become increasingly popular. PFAS are commonly use as surface treatment/coatings in consumer products such as carpets, upholstery, stain resistant apparel, cookware, paper, packaging, and the like, and may also be found in chemicals used for chemical plating, electrolytes, lubricants, and the like, which may eventually end up in the water supply. Further, PFAS have been utilized as key ingredients in aqueous film forming foams (AFFFs). AFFFs have been the product of choice for firefighting at military and municipal fire training sites around the world. AFFFs have also been used extensively at oil and gas refineries for both fire training and firefighting exercises. AFFFs work by blanketing spilled oil/fuel, cooling the surface, and preventing re-ignition. PFAS in AFFFs have contaminated the groundwater at many of these sites and refineries, including more than 100 U.S. Air Force sites.

Although used in relatively small amounts, these compounds are readily released into the environment where their extreme hydrophobicity as well as negligible rates of natural decomposition results in environmental persistence and bioaccumulation. It appears as if even low levels of bioaccumulation may lead to serious health consequences for contaminated animals such as human beings, the young being especially susceptible. The environmental effects of these compounds on plants and microbes are as yet largely unknown. Nevertheless, serious efforts to limit the environmental release of PFAS are now commencing.

Use of adsorption media is one technique for treating water containing PFAS. It may be desirable to have flexibility in terms of what type of media is used for water treatment within a stream of water. For example, the source and/or constituents of the process water to be treated may be a relevant factor. Various federal, state and/or municipal regulations may also be factors. The U.S. Environmental Protection Agency (EPA) developed revised guidelines in May 2016 of a combined lifetime exposure of 70 parts per trillion (PPT) for PFOS and PFOA. In June 2022, this EPA guidance was tightened to a recommendation of 0.004 ppt lifetime exposure for PFOA and 0.02 ppt lifetime exposure for PFOS. Federal, state, and/or private bodies may also issue relevant regulations. In some embodiments, other approaches for PFAS removal, such as the use of ion exchange resin, may be used in conjunction with activated carbon treatment as described herein. Market conditions may also be a controlling factor. These factors may be variable and therefore a preferred water treatment approach may change over time.

In accordance with one aspect, there is provided a method of treating water containing PFAS. The water may contain at least 10 ppt PFAS, for example, at least 1 ppb PFAS. For example, the waste stream may contain at least 10 ppt-1 ppb PFAS, at least 1 ppb-10 ppm PFAS, at least 1 ppb-10 ppb PFAS, at least 1 ppb-1 ppm PFAS, or at least 1 ppm-10 ppm PFAS.

In certain embodiments, the water to be treated may include PFAS with other organic contaminants. One issue with treating PFAS compounds in water is that the other organic contaminants compete with the various processes to remove PFAS. For example, if the level of PFAS is 80 ppb and the background TOC is 50 ppm, a conventional PFAS removal treatment, such as an activated carbon column, may exhaust very quickly. Thus, it may be important to remove TOC prior to treatment to remove PFAS.

Thus, in some embodiments, the systems and methods disclosed herein may be used to remove background TOC, prior to treating the water for removal of PFAS. The methods may be useful for oxidizing target organic alkanes, alcohols, ketones, aldehydes, acids, or others in the water. In some embodiments, the water containing PFAS further may contain at least 1 ppm TOC. For example, the water containing PFAS may contain at least 1 ppm-10 ppm TOC, at least 10 ppm-50 ppm TOC, at least 50 ppm-100 ppm TOC, or at least 100 ppm-500 ppm TOC.

In some embodiments, the removal material, e.g., adsorption media, used to remove the PFAS can be any suitable removal material, e.g., adsorption media, that can interact with the PFAS in the water to be treated and effectuate its removal, e.g., by being loaded onto the removal material. In general, the removal materials, e.g., adsorption media, disclosed herein may be bifunctional with respect to facilitating PFAS removal and driving downstream treatment processes, such as combustion or oxidation. Carbon-based removal materials, e.g., activated carbon, and resin media are both widely used for the removal of organic and inorganic contaminates from water sources. For example, activated carbon may be used as an adsorbent to treat water. In some embodiments, the activated carbon may be made from bituminous coal, coconut shell, or anthracite coal. The activated carbon may generally be a virgin or a regenerated activated carbon. In some embodiments, the activated carbon may be a modified activated carbon. The activated carbon may be present in various forms, i.e., a granular activated carbon (GAC) or a powdered activated carbon (PAC).

In accordance with one or more embodiments, GAC may refer to a porous adsorbent particulate material, produced by heating organic matter, such as coal, wood, coconut shell, lignin or synthetic hydrocarbons, in the absence of air, characterized that the generally the granules or characteristic size of the particles are retained by a screen of 50 mesh (50 screen openings per inch in each orthogonal direction).

Without wishing to be bound by any particular theory, PAC typically has a larger surface area for adsorption that GAC and can be agitated and flowed more easily, increasing its effective use. Various activated carbon media for water treatment are known to those of ordinary skill in the art. In at least some non-limiting embodiments, the media may be an activated carbon as described in U.S. Pat. Nos. 8,932,984 and/or 9,914,110, both to Evoqua Water Technologies LLC, the entire disclosure of each of which is hereby incorporated herein by reference in its entirety for all purposes.

In some embodiments, separation of PFAS from a source of contaminated water may be achieved using an adsorption process, where the PFAS are physically captured in the pores of a porous material (i.e., physisorption) or have favorable chemical interactions with functionalities on a filtration medium (i.e., chemisorption). In accordance with one or more embodiments, the PFAS separation stage may include adsorption onto an electrochemically active substrate. An example of an electrochemically active substrate that can be used to adsorb PFAS is granular activated carbon (GAC). Adsorption onto GAC, compared to other PFAS separation methods, is a low-cost solution to remove PFAS from water that can potentially avoid known issues with other removal methods, such as the generation of large quantities of hazardous regeneration solutions of ion exchange vessels and the lower recovery rate and higher energy consumption of membrane-based separation methods such as nanofiltration and reverse osmosis (RO).

The removal material as described herein is not limited to particulate media, e.g., activated carbons, or cyclodextrins. Any suitable removal material, e.g., adsorption media, may be used to adsorb or otherwise bind with pollutants and contaminants present in the waste stream, e.g., PFAS. For example, suitable removal material may include, but are not limited to, alumina, e.g., activated alumina, aluminosilicates and their metal-coordinated forms, e.g., zeolites, silica, perlite, diatomaceous earth, surfactants, ion exchange resins, and other organic and inorganic materials capable of interacting with and subsequently removing contaminants and pollutants from the waste stream.

In certain non-limiting embodiments, this disclosure describes water treatment systems for removing PFAS from water and methods of treating water containing PFAS. Systems described herein include a contact reactor containing a removal material, e.g., an adsorption media, that has an inlet fluidly connected to a source of water containing PFAS. The removal material, after being exposed to PFAS and removing it from the water, e.g., by becoming loaded with PFAS, may be directed from an outlet of the contact reactor to an inlet of a separation system positioned downstream of the contact reactor. The separation system separates treated water, i.e., water containing a lower concentration of PFAS than the source water, and the removal material, e.g., adsorption media. The removal material, e.g., adsorption media can be further processed as disclosed herein.

In accordance with one or more embodiments, granular activated carbon (GAC) may specifically be further processed as disclosed further herein.

In accordance with one or more embodiments, a water treatment system may include a source of water connectable by conduit to an inlet of an upstream separation system that can produce a treated water and a stream enriched in PFAS. A first separation system can be any suitable separation system that can produce a stream enriched in PFAS or other compounds. For example, the upstream separation system can be a reverse osmosis (RO) system, a nanofiltration (NF) system, an ultrafiltration system (UF), or electrochemical separations methods, e.g., electrodialysis, electrodeionization, etc. In such implementations, the reject, retentate or concentrate streams from these types of separation systems will include water enriched in PFAS. For example, the concentration increase of PFAS in the water upon concentrating may be at least 20× relative to the initial concentration of PFAS before concentration, e.g., at least 20×, at least 25×, at least 30×, at least 35×, at least 40×, at least 45×, at least 50×, at least 55×, at least 60×, at least 65×, at least 70×, at least 75×, at least 80×, at least 85×, at least 90×, at least 95×, or at least 100×. In some embodiments of the system, water from the source of water, or another source of PFAS containing water, can be directed into the contact reactor via conduit without the need for upstream separation to produce a stream of water enriched in PFAS.

The treated water produced by the system may be substantially free of the PFAS. The treated water being “substantially free” of the PFAS may have at least 90% less PFAS by volume than the waste stream. The treated water being substantially free of the PFAS may have at least 92% less, at least 95% less, at least 98% less, at least 99% less, at least 99.9% less, or at least 99.99% less PFAS by volume than the waste stream. Thus, in some embodiments, the systems and methods disclosed herein may be employed to remove at least 90% of PFAS by volume from the source of water. The systems and methods disclosed herein may remove at least 92%, at least 95%, at least 98%, at least 99%, at least 99.9%, or at least 99.99% of PFAS by volume from the source of water. In certain embodiments, the systems and methods disclosed herein are associated with a PFAS removal rate of at least about 99%, e.g., about 99%, about 99.1%, about 99.2%, about 99.3%, about 99.4%, about 99.5%, about 99.6%, about 99.7%, about 99.8%, about 99.9%, about 99.95%, or about 99.99%.

To remove the collected PFAS-loaded removal material, e.g., adsorption media such as GAC, the separation elements of the downstream separation system can be backwashed to release the PFAS-loaded removal material to form a slurry stream. The water for backwashing the separation elements may come from a source of backwash water fluidly coupled to the downstream separation system via conduit. The water from source of backwash can be any suitable source of water and in general is water of lower quality so as to not excessively use highly treated water for cleaning and maintenance purposes. In some embodiments, treated water from the system may be recycled for use as backwash water if desired. For membrane separators, the backwashing period to form the slurry stream may be determined a length of time the membrane has been in service, a change in pressure of the water being passed through the membrane, a water quality parameter, or another factor indicative that the membrane is past its service life. The backwash process may occur automatically, e.g., a set or fixed schedule or as needed, e.g., controlled by a controller with inputs including appropriate sensors and outputs including valves, or manually by an end user or operator.

In accordance with one or more embodiments, there is provided a method of treating water containing PFAS. The method may include dosing water containing PFAS with adsorption media to promote loading of the adsorption media with PFAS. The method further may include producing a slurry stream including the PFAS-loaded adsorption media. In some embodiments, the PFAS include one or more PFOS and PFOA. The PFAS-loaded adsorption media, e.g. GAC, may be processed as described herein.

In some embodiments, the slurry stream including the loaded adsorption media is produced via a filtration and backwash operation. In further embodiments, the method may include concentrating the slurry stream prior to further treatment. In further embodiments, the method may include concentrating the water containing PFAS prior to introduction to the adsorption media, e.g., using a membrane concentrator, e.g., with a dynamic membrane. For example, the concentration increase of PFAS in the water upon concentrating may be at least 20× relative to the initial concentration of PFAS before concentration, e.g., at least 20×, at least 25×, at least 30×, at least 35×, at least 40×, at least 45×, at least 50×, at least 55×, at least 60×, at least 65×, at least 70×, at least 75×, at least 80×, at least 85×, at least 90×, at least 95×, or at least 100×.

In further embodiments, the dosage of adsorption media may be adjusted based on at least one quality parameter of the water to be treated. For example, the at least one quality parameter may include a target concentration of the PFAS in the treated water to be at or below a specified regulatory threshold.

In accordance with one or more embodiments, carbon reactivation includes a method of thermally processing activated carbon, to remove adsorbed components contained within its pores without substantial damage to the original porosity of the carbon. Carbon reactivation is commonly performed by subjecting the carbon to elevated temperatures typically but not limited to temperatures of 700° C. to 800° C. in a controlled atmosphere including water vapor in a rotating kiln or multiple hearth furnace. It can be distinguished from carbon regeneration which may utilize solvents, chemicals, steam, or wet oxidation processes for removal of adsorbed components. During the reactivation process approximately 5% to 10% of the original carbon is reduced to carbon fines or is vaporized.

In accordance with one or more embodiments, systems and methods to remove PFAS compounds from an activated carbon reactivation process are disclosed. The systems and methods may generally include reactivation of granular activated carbon (GAC) containing PFAS, thermal oxidation of a related vapor phase effluent, and downstream processing. Reactivation may involve countercurrent flow of gas in a kiln. A vapor phase effluent out of the kiln may be treated via thermal oxidization or via an internal combustion engine to produce an intermediate vapor effluent. Wet scrubbing may accompany the thermal destruction operation. An intermediate effluent produced by the thermal destruction operation may be polished to remove any residual PFAS compounds, either volatile or those in aerosols or condensed steam. Polishing may involve a vapor phase GAC column and/or an internal combustion engine.

In accordance with one or more embodiments, the process without the polishing stage is known to eliminate 99.99% of the PFAS and other organic compounds, so the polishing stage can get product emissions below detection limits. In at least some embodiments, the intermediate vapor effluent contains PFAS at a concentration below detectable limits and the polishing stage produces a product effluent having a PFAS concentration at or below that of the intermediate effluent. In some embodiments, the intermediate effluent is characterized by a PFAS elimination rate of at least about 99% by weight for at least one of the PFAS compounds originally in the granular activated carbon, based on a measure of the weight of the particular measured PFAS compound that is released from the reactivated GAC during reactivation. In some specific non-limiting embodiments, the intermediate vapor effluent is characterized by a PFAS elimination rate of at least about 99.99% by weight for at least one of the PFAS compounds originally in the granular activated carbon, based on a measure of the weight of the particular measured PFAS compound that is released from the reactivated GAC during reactivation.

In some embodiments, a GAC column may be included in the recirculating water of the wet scrubber. Solids may be removed by a coarse filter and then run through a liquid phase GAC column to remove any dissolved PFAS compounds that make their way through to the scrubber after the thermal oxidizer. There is an extremely low level of PFAS so there would be a very long life on the liquid phase GAC. Also, less scrubber water will be needed to replenish. This is a major expense since the water is replaced twice/week and must be treated as a liquid waste. The liquid phase GAC in this column can be reactivated.

In some embodiments, an ion exchange column may be included in the recirculating water of the wet scrubber. Some conventional anion selective exchange resins have shown to be effective on the longer alkyl chain PFAS but have reduced bed lives when treating shorter alkyl chain compounds. Once the ion exchange resins are exhausted they must be removed from the site and are often destroyed by incineration under conditions and at temperatures above the mineralization temperatures of PFAS. Applicable ion exchange technologies would be readily recognizable to those of ordinary skill in the relevant art.

In accordance with one or more embodiments, one option for eliminating the recovered or displaced hydrocarbon vapors is to incorporate them into a fuel or air stream for intake into an internal combustion engine, thereby incorporating the volatile vapors into the fuel/air combustion process. Such an internal combustion engine is disclosed in U.S. Pat. No. 5,424,045, the disclosure of which is incorporated herein by reference in its entirety. It is proposed to optionally use an internal combustion engine to destroy PFAS compounds by introducing a liquid possibly atomized into an internal combustion engine so that PFAS is mineralized in the fuel/air combustion process. The temperature of operation of an internal combustion engine using a hydrocarbon-based fuel can be over 1000° C. For example, CNG (Compressed Natural Gas) has a peak flame temperature of 1790° C. which is 187° C. or 9.5% cooler than the peak flame temperature of gasoline at 1977° C. The peak flame temperature of propane at 1991° C. is only 13° C. or about 1% higher than gasoline. A Diesel engine can have an operating temperature of over 2500° C. due to the greater operating pressure. An internal combustion engine (4 stroke) using gasoline may have a compression ratio of about 9:1. A Diesel engine may have a compression ratio of 20:1 or greater which accounts for the greater combustion temperature.

Once the GAC column has reached the capacity to remove PFAS, it may be placed in a cleaning mode. An eluent is directed through the GAC column which results in a waste stream that comprises PFAS and the eluent. The waste stream is directed to a thermal destruction process or an internal combustion engine (ICE). A source of oxygen containing gas such as air and a source of fuel are both introduced to the ICE. The ICE is operated so that the fuel/air mixture undergoes combustion. The temperature of the combustion process mineralizes the PFAS. The exhaust from the ICE may be directed to a catalytic converter and/or polished downstream as described herein. The operation of the ICE results in an axial motion of a drive shaft which is used to drive an electric generator. The resulting electricity is used to operate the ancillary equipment of the system or directed to the electric grid. The eluent can be a volatile compound such as a hydrocarbon. An alcohol such as methanol would be an example. Any water-soluble volatile compound may be suitable including other alcohols and organic compounds. The eluent could be cyclodextrin. This invention is not limited to the type of eluent.

In some embodiments, the source of oxygen containing gas may be derived from a gas separation process. This process with increase the concentration of oxygen in air from about 21% to as much as 99%. Using enriched oxygen for the ICE combustion will make the combustion more efficient and also reduce the formation of oxides of nitrogen (NOx) which causes air pollution. One such gas separation process is the PRISM gas separation module from Air Products, Allentown, PA. The ICE may comprise a four-stroke engine using a fuel source that comprises a hydrocarbon such as propane or gasoline. The type of fuel used is non-limiting. The ICE may comprise a Diesel engine that uses diesel fuel or bio-diesel fuel as the fuel source.

In accordance with one or more embodiments, the disclosed internal combustion engine (ICE) unit operation may be used for polishing an intermediate effluent produced by a thermal destruction process. In other embodiments, the ICE may be used in place of the thermal destruction process and produce an intermediate vapor effluent that can be polished via a vapor phase GAC column.

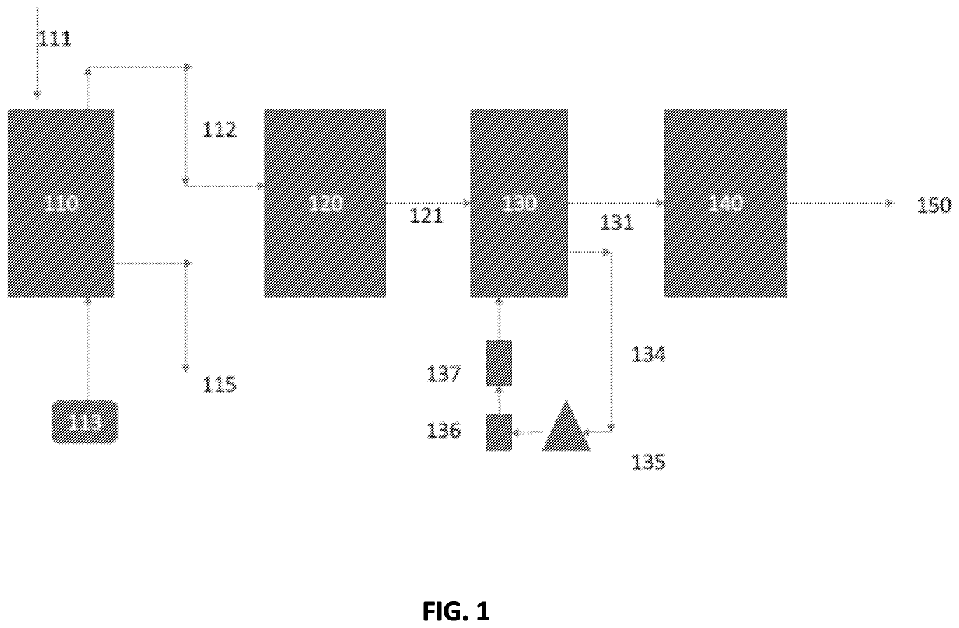

Referring to FIG. 1, influent 111 comprising granulated activated carbon (GAC) is directed to a reactivation kiln or furnace 110. A source of heated gas 113 is directed into the kiln 110. The temperature of the kiln may be in the range of 700° C. to 1000° C. Reactivated carbon 115 is now ready for reuse. The effluent 112 or off gas from the kiln 110 is directed to a thermal oxidizer 120 or after burner where the temperature may be in the range of 800° C. to 1200° C. Alternatively, unit operation 120 may be an internal combustion engine as described herein. The effluent from the thermal oxidizer or internal combustion engine 121 is directed to a wet scrubber 130. A recirculation line 134 recirculates the scrubber water through a pump 135, through a particle filter 136 and then through a liquid phase GAC column 137 before being returned to the wet scrubber 130. As described above, an ion exchange column may be included in the recirculation loop. This recirculation line will prevent build-up of PFAS materials in the scrubber water. The effluent from the scrubber 130 is directed to a GAC column 140 that operates in the vapor phase. Alternatively, unit operation 140 may be an internal combustion engine as described herein. The effluent or exhaust 150 from the GAC column or internal combustion engine 140 is vented to atmosphere.

The life of the carbon contained in liquid phase GAC column 137 and/or vapor phase GAC column 140 will be very high and when exhausted can be recycled through the reactivation kilns and reused.

In accordance with one or more embodiments as described above, the thermal oxidizer may be replaced by other thermal based destruction apparatus such as an internal combustion engine (ICE). This disclosure is not limited by the type, number or configuration of the thermal destruction apparatus.

In accordance with one or more embodiments, GAC containing PFAS may be de-watered or otherwise concentrated prior to being introduced to the reactivation kiln.

In some embodiments, systems disclosed herein can be designed for centralized applications, onsite application, of mobile applications via transportation to a site. The centralized configuration can be employed at a permanent processing plant such as in a permanently installed water treatment facility such as a municipal water treatment system. The onsite and mobile systems can be used in areas of low loading requirement where temporary structures are adequate. A mobile unit may be sized to be transported by a semi-truck to a desired location or confined within a smaller enclosed space such as a trailer, e.g., a standard 53′ trailer, or a shipping container, e.g., a standard 20′ or 40′ intermodal container.

The function and advantages of these and other embodiments can be better understood from the following example. This example is intended to be illustrative in nature and are not considered to be in any way limiting the scope of the invention.

### Prophetic Example

A system for treating activated carbon used in treatment of water and wastewater containing a per- or poly-fluoroalkyl substance (PFAS) will be retrofit by fluidly connecting a vapor phase granular activated carbon (GAC) column 140 downstream of a thermal oxidizer 120 and wet scrubber 130 in accordance with the process flow diagram of FIG. 1.

GAC column 140 will serve as a backup system to ensure fail-safe complete removal of PFAS from stack off-gas post water quench.

The vapor phase GAC column 140 may have the following design parameters:
Air flow (dscm): 250 dscm/min to 400 dscm/min.
Stack gas moisture: about 30% to about 45%
O2 dry Volume: about 9%
Dry CO2 Volume: about 7%
Stack Temperature: about 165° F. to about 185° F.

These design parameters are for example only and are non-limiting.

The feed vapor 131 to GAC column 140 may contain the following PFAS compounds at or near detection limit to facilitate sizing of the vapor phase GAC polishing column:

Feed Vapor Quality Information - PFAS compounds at or near detection
limit - design sizing as basis for carbon necessary as backup

| | Feed Vapor | |
|---|---|---|
| Constituent | Concentration^{(d)} | Unit |
| PFBA | 48.64E−06 | ug/L |
| PFPeA | 14.284E−06 | ug/L |
| PFHxA | 8.74E−06 | ug/L |
| PHHpA | 1.35E−06 | ug/L |
| PFOA | 1.82E−06 | ug/L |
| PFBS | 2.82E−06 | ug/L |
| 6:2 FTS | 3.43E−06 | ug/L |
| NMeFOSA | 2.27E−06 | ug/L |
| HFPO-DA | 443.06E−06 | ug/L |

The vapor phase polishing GAC column 140 may contain 5000 lbs of carbon to treat the vapor effluent from the reactivation system. It would be able to process the vapor used to reactivate over 100,000,000 lbs of carbon before the polisher carbon itself needed reactivation. This may equate to an estimated carbon usage rate of about 0.577 pounds per day, efficiently requiring a carbon change-out every 2.3 years of operation.

A liquid phase GAC column 137 around the recirculating water of the wet scrubber as illustrated in FIG. 1 may also be efficiently integrated.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

1. A method of treating granular activated carbon (GAC) used in treatment of water or wastewater containing a per- or poly-fluoroalkyl substance (PFAS), comprising:
reactivating GAC containing adsorbed PFAS;
subjecting a first vapor phase effluent associated with reactivation to a thermal oxidation process to produce an intermediate vapor effluent; and
polishing the intermediate vapor effluent with a treatment capable of eliminating PFAS to produce a product effluent.

2. The method of claim 1, wherein the PFAS comprises perfluorooctane sulfonic acid (PFOS), perfluorooctanoic acid (PFOA), or a perfluoroalkyl ether carboxylic acid.

3. The method of claim 1, wherein the thermal oxidation process comprises combustion.

4. The method of claim 1, wherein the thermal oxidation process involves a process temperature in a range of about 800° C. to about 1200° C.

5. The method of claim 1, wherein the thermal oxidation process further comprises wet scrubbing.

6. The method of claim 5, further comprising recirculating scrubbing fluid through a particle filter.

7. The method of claim 5, further comprising recirculating scrubbing fluid through a liquid phase GAC column.

8. The method of claim 5, further comprising recirculating scrubbing fluid through a liquid phase ion exchange column.

9. The method of claim 1, wherein polishing involves subjecting the intermediate vapor effluent to a vapor phase GAC column.

10. (canceled)

11. (canceled)

12. The method of claim 1, wherein polishing involves subjecting the intermediate vapor effluent to an internal combustion engine.

13. (canceled)

14. (canceled)

15. The method of claim 7, further comprising reactivating spent carbon associated with the liquid phase GAC column.

16. (canceled)

17. The method of claim 9, further comprising reactivating spent carbon associated with the vapor phase GAC column.

18. (canceled)

19. The method of claim 1, further comprising concentrating or dewatering a process stream including the GAC containing adsorbed PFAS prior to reactivation.

20. (canceled)

21. (canceled)

22. (canceled)

23. (canceled)

24. A system for treating granular activated carbon (GAC) used in treatment of-water or wastewater containing a per- or poly-fluoroalkyl substance (PFAS), comprising:
a GAC reactivation kiln;
a thermal destruction unit fluidly connected downstream of a first effluent associated with the GAC reactivation kiln, the thermal destruction unit configured to produce an intermediate vapor effluent; and
a polishing unit fluidly connected downstream of the intermediate vapor effluent associated with the reactivation kiln and thermal destruction unit.

25. The system of claim 24, wherein the thermal destruction unit comprises a thermal oxidizer.

26. The system of claim 24, wherein the thermal destruction unit comprises an internal combustion engine.

27. The system of claim 25, wherein the thermal destruction unit further comprises a wet scrubber.

28. (canceled)

29. (canceled)

30. (canceled)

31. The system of claim 24, wherein the polishing unit comprises a vapor phase GAC column.

32. The system of claim 24, wherein the polishing unit comprises an internal combustion engine.

33. The system of claim 24, wherein the intermediate vapor effluent is controlled to meet a PFAS elimination rate of at least about 99% by weight for at least one of the PFAS compounds originally in the GAC.

34. (canceled)

35. (canceled)

36. (canceled)
